(19) United States
(12) Patent Application Publication
(10) Pub. No.: US 2024/0360586 A1
(43) Pub. Date: Oct. 31, 2024

(54) METHOD AND SYSTEM FOR REGENERATING ELECTROLYTIC COPPER PLATING SOLUTION

(71) Applicant: C. Uyemura & Co., Ltd., Osaka-shi (JP)

(72) Inventors: Takuya OKAMACHI, Osaka (JP); Shinji TACHIBANA, Osaka (JP); Katsuhisa TANABE, Osaka (JP); Masaaki SATO, Osaka (JP); Yukinori ODA, Jurong (SG)

(21) Appl. No.: 18/644,980

(22) Filed: Apr. 24, 2024

(30) Foreign Application Priority Data
Apr. 28, 2023 (JP) 2023-074822

(51) Int. Cl. C25D 21/18; C25D 3/38; C25D 17/02

(52) U.S. Cl. CPC C25D 21/18; C25D 3/38; C25D 17/02

(57) ABSTRACT

A method for regenerating an electrolytic copper plating solution containing a copper ion and at least one additive selected from the group consisting of a brightener, a carrier, and a leveler at least includes: ultraviolet-ozone treatment of oxidizing the electrolytic copper plating solution to decompose an organic impurity in the electrolytic copper plating solution; and activated carbon treatment of bringing activated carbon into contact with the electrolytic copper plating solution which has been subjected to the ultraviolet-ozone treatment to remove the organic impurity in the electrolytic copper plating solution.

### CROSS-REFERENCE TO RELATED APPLICATION

This application claims priority to Japanese Patent Application No. 2023-074822 filed on Apr. 28, 2023, the entire disclosure of which is incorporated by reference herein.

### BACKGROUND

The present disclosure relates to a method and system for regenerating an electrolytic copper plating solution.

In the field of electronic parts, an electrolytic copper plating film has been formed on a pattern formed of a photoresist on an organic package substrate, a flexible substrate, or a silicon wafer substrate.

In electrolytic copper plating, when an electrolytic treatment continues using an electrolytic copper plating solution, organic impurities such as by-products generated due to decomposition of additives and eluates of the photoresist increase over time, and therefore, there is a problem that the plating performance is deteriorated.

Given these circumstances, as a measure therefor, a method is proposed which uses activated carbon to remove such organic impurities. More specifically, a method has been proposed that uses an activated carbon cartridge to remove such organic impurities (e.g., sodium salts of propanedisulfonic acid and low molecular weight polyethers) at regular intervals (see, for example, International Publication No. WO 2016/174705).

### SUMMARY

Even though the electrolytic treatment continues using an electrolytic copper plating solution containing additives such as a leveler, a brightener, and a carrier, organic impurities such as by-products of the additive increase over time, in the method for treating an electrolytic copper plating solution described in Patent Document 1, an activated carbon cartridge is used to merely remove the organic impurities periodically. The method does not sufficiently handle the increase in organic impurities, and the organic impurities cannot be removed efficiency.

Thus, the concentration of the organic impurities in the electrolytic copper plating solution increases over time, and the plating performance decreases, so that there is a problem that another plating solution needs to be newly prepared.

In view of the problems described above, it is therefore an object of the present invention to provide a method for regenerating an electrolytic copper plating solution. The method is capable of regenerating the electrolytic copper plating solution without newly preparing another plating solution, by reducing the concentrations of the organic impurities in the plating solution to a level below the standard value at which the plating solution can be continuously used.

In order to achieve the above objective, a method for regenerating an electrolytic copper plating solution according to the present disclosure is directed to a method for regenerating an electrolytic copper plating solution containing a copper ion and at least one additive selected from the group consisting of a brightener, a carrier, and a leveler. The method includes: ultraviolet-ozone treatment of oxidizing the electrolytic copper plating solution to decompose an organic impurity in the electrolytic copper plating solution; and activated carbon treatment of bringing activated carbon into contact with the electrolytic copper plating solution which has been subjected to the ultraviolet-ozone treatment to remove the organic impurity in the electrolytic copper plating solution.

A system for regenerating an electrolytic copper plating solution according to the present disclosure is directed to a system for regenerating an electrolytic copper plating solution containing a copper ion and at least one additive selected from the group consisting of a brightener, a carrier, and a leveler. The system includes: an ultraviolet-ozone treatment device configured to oxidize the electrolytic copper plating solution to decompose an organic impurity in the electrolytic copper plating solution; and an activated carbon treatment device configured to bring activated carbon into contact with the electrolytic copper plating solution which has been subjected to an ultraviolet-ozone treatment to remove the organic impurity in the electrolytic copper plating solution.

According to the present disclosure, the ultraviolet-ozone treatment and the activated carbon treatment are performed. Thus, it is possible to regenerate the electrolytic copper plating solution without replacement by reducing the concentrations of the organic impurities in the plating solution to a level below the standard value at which the plating solution can be continuously used. This makes it possible to continuously use the electrolytic copper plating solution semi-permanently without newly preparing another plating solution.

### BRIEF DESCRIPTION OF THE DRAWINGS

FIG. 1 is a diagram for illustrating a method for regenerating an electrolytic copper plating solution according to the present disclosure.

FIG. 2 is a diagram for illustrating an ultraviolet-ozone treatment device used in the method for regenerating an electrolytic copper plating solution according to the present disclosure.

FIG. 3 is a diagram for illustrating a variation of the method for regenerating an electrolytic copper plating solution according to the present disclosure.

FIG. 4 is a diagram for illustrating an electrolytic copper plating film of Example 1.

FIG. 5 is a diagram for illustrating a measurement method for a recessed amount in via hole filling plating in Example 1.

FIG. 6 is a graph showing measurement results of total organic carbon (TOC) values in Example 1.

FIG. 7 is a graph showing measurement results of recessed amounts in via hole filling plating in Example 1.

### DETAILED DESCRIPTION

A method for regenerating an electrolytic copper plating solution (hereinafter also referred to as the regeneration method) according to the present disclosure will be described below.

### <Plating Solution to be Treated>

A plating solution to which the regeneration method according to the present disclosure is applied is an electrolytic copper plating solution. The electrolytic copper plating solution is not particularly limited, and examples thereof include a copper sulfate plating solution, copper cyanide, and copper pyrophosphate. In the present disclosure, an example where the copper sulfate plating solution is used as the electrolytic copper plating solution to which the regeneration method is applied will be described below.

The copper sulfate plating solution can be, for example, a plating solution containing: water as a solvent; an electric conducting salt such as a sulphate ion; a copper ion; at least one additive selected from the group consisting of a brightener, a carrier, and a leveler; and a chloride ion source.

The source of the electric conducting salt is not particularly limited, and examples thereof used include sulfuric acid, copper sulfate, methanesulfonic acid, and hydrates thereof (e.g., copper sulfate pentahydrate). These sources of the electric conducting salt may be used alone or in combination of two or more of them.

The concentration of the sulphate ion in the copper sulfate plating solution is not particularly limited, and is preferably 1 g/L to 300 g/L, more preferably 50 g/L to 200 g/L, in view of improving uniformity of the plating film and filling performance.

The source of the copper ion is not particularly limited, and examples thereof used include copper sulfate, copper methanesulfonate, phosphorus-containing copper, copper oxide, and hydrates thereof (e.g., copper sulfate pentahydrate). These sources of the copper ion may be used alone or in combination of two or more of them.

The concentration of the copper ion in the copper sulfate plating solution is not particularly limited, and is preferably 5 g/L to 90 g/L, more preferably 20 g/L to 50 g/L, in view of improving uniformity of the plating film and filling performance.

The source of the chloride ion is not particularly limited, and examples thereof used include sodium chloride and hydrochloric acid. These sources of the chloride ion may be used alone or in combination of two or more of them.

The concentration of the chloride ion in the copper sulfate plating solution is not particularly limited, and is preferably 0.1 g/L to 300 g/L, more preferably 0.5 g/L to 100 g/L, in view of improving uniformity of the plating film and filling performance.

The copper sulfate plating solution may contain a leveler as an additive. As the leveler, a nitrogen-containing organic compound is used, and examples thereof used include diallyldimethylammonium chloride polymer, diallyldimethylammonium chloride-sulfur dioxide copolymer, part 3-chloro-2-hydroxy propylated diarylamine hydrochloride-diaryl dimethyl ammonium chloride copolymer, diaryl dimethyl ammonium chloride-acrylamide copolymer, diarylamine hydrochloride-sulfur dioxide copolymer, arylamine hydrochloride polymer, arylamine (free) polymer, arylamine hydrochloride-diarylamine hydrochloride copolymer, polymer of diamine and epoxy, polymer of morpholine and epichlorohydrin, diethylenetriamine, denatured epichlorohydrin of polycondensate consists of adipic acid and ε-caprolactam, polyethyleneimine and a derivative thereof, polyvinylimidazole and a derivative thereof, polyvinyl alkyl imidazole and a derivative thereof, copolymer of vinylpyrrolidone and vinyl alkyl imidazole and a derivative thereof, and dyes such as Janus Green B. These levelers may be used alone or in combination of two or more of them.

The concentration of the leveler in the copper sulfate plating solution is not particularly limited, and is preferably 0.01 g/L to 3000 mg/L, more preferably 0.05 g/L to 2000 g/L, in view of improving uniformity of the plating film and flatness of the surface shape.

The copper sulfate plating solution may contain a brightener as an additive. As the brightener, a sulfur-containing organic compound is used, and examples thereof used include the sulfur-containing compounds represented by the formulae (1) to (3). These brighteners may be used alone or in combination of two or more of them.

[Chemical 1]

R1-S—(CH₂)ₙ—(O)ₚ—SO₃M (1)

(R₂)₂N—CSS—(CH₂)ₙ—(CHOH)ₚ—(CH₂)ₙ—(O)ₚ—SO₃M (2)

R2-O—CSS—(CH₂)ₙ—(CHOH)ₚ—(CH₂)ₙ—(O)ₚ—SO₃M (3)

(In the formula, R1 is a hydrogen atom or a group represented by —(S)ₘ—(CH₂)ₙ—(O)ₚ—SO₃M, R2s are each independently an alkyl group with 1 to 5 carbon atoms, M is a hydrogen atom or an alkali metal, m is 0 or 1, n is an integer of 1 to 8, p is 0 or 1.)

Specific examples thereof used include organic thiocompounds, organic acid amides, and oxygen-containing polymer organic compounds.

The concentration of the brightener in the copper sulfate plating solution is not particularly limited, and is preferably 0.01 mg/L to 1000 m mg/L, more preferably 0.05 mg/L to 500 mg/L.

The copper sulfate plating solution may contain a carrier as an additive. As a carrier, polyether compound is used, and examples thereof used include compounds including polyalkylene glycols containing four or more ether bonds (—O—) such as polyethylene glycol, polypropylene glycol, and copolymers thereof, polyethylene glycol fatty acid ester, and polyethylene glycol alkylether. These carriers may be used alone or in combination of two or more of them.

The concentration of the carrier in the copper sulfate plating solution is not particularly limited, and is preferably 5 mg/L to 5000 mg/L, more preferably 10 mg/L to 3000 mg/L in view of improving throwing power.

The copper sulfate plating solution may further contain other additives unless the advantages of the present invention are impaired. When the copper sulfate plating solution is used to form a plating film, the pH of the plating solution is 1 or less.

The temperature at which the plating film is formed is not particularly limited, and is preferably 20° C. to 50° C. The current density at which the plating film is formed is not particularly limited, and is preferably 0.1 A/dm² to 10 A/dm², more preferably 0.5 A/dm² to 8 A/dm².

The copper sulfate plating solution can be used for formation of plated bumps of semiconductor chips and package substates, for example. In forming the plated bumps, reflow treatment may be performed after a plating film with a predetermined size is formed at a predetermined position. This reflow treatment is not limited to particular reflow treatment and can be performed using a normal reflow apparatus.

### <Method for Regenerating Electrolytic Copper Plating Solution>

As mentioned above, when the electrolytic treatment continues using an electrolytic copper plating solution containing an additive such as a leveler, a brightener, and a carrier, organic impurities such as by-products of the additive (e.g., carboxylic acid, which is a by-product due to decomposition of carrier) and eluates of photoresist increase over time. As a result, there is a problem that the plating performance decreases.

Given these circumstances, the inventors of the present invention have studied the above problem and found as follows. The electrolytic copper plating solution containing the impurities is circulated and subjected to the ultraviolet-ozone treatment to decompose the organic impurities and brought into contact with activated carbon to remove the organic impurities. It is thus possible to regenerate the electrolytic copper plating solution by reducing the concentrations of the organic impurities in the plating solution to a level below the standard value at which the plating solution can be continuously used.

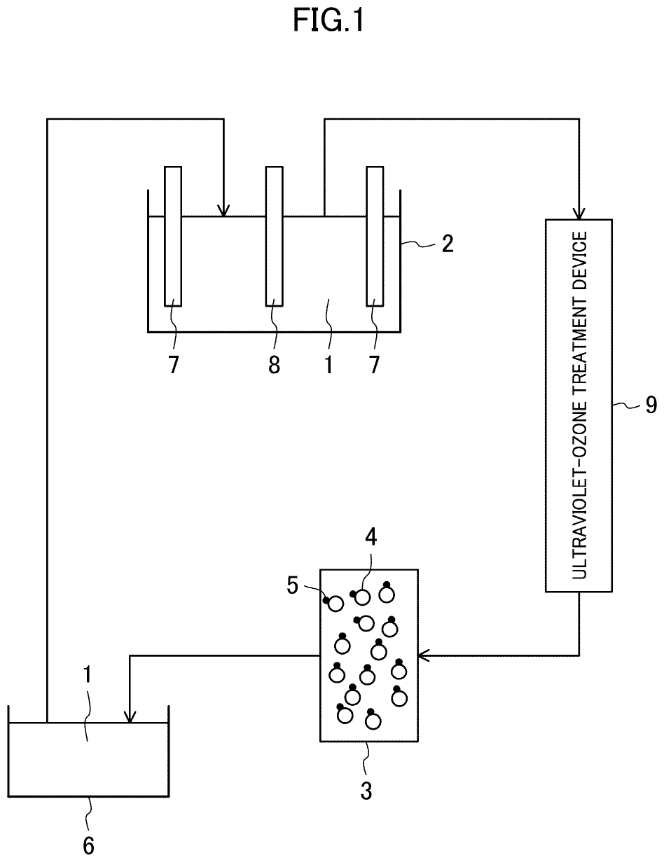

The following specifically describes the method for regenerating the electrolytic copper plating solution according to the present disclosure with reference to the accompanying drawings. FIG. 1 is a schematic view for illustrating a method for regenerating the electrolytic copper plating solution according to the present disclosure.

As illustrated in FIG. 1, the method for regenerating an electrolytic copper plating solution according to the present disclosure includes: ultraviolet-ozone treatment of oxidizing an electrolytic copper plating solution 1 (i.e., the electrolytic copper plating solution containing an additive such as a leveler, a brightener, and a carrier) contained in a plating tank 2 by an ultraviolet-ozone treatment device 9 disposed in a circulation path of the electrolytic copper plating solution 1 to decompose organic impurities (i.e., organic impurities such as by-products of the additive and eluates of photoresist) in the electrolytic copper plating solution 1; and activated carbon treatment of bringing the electrolytic copper plating solution 1 which has been subjected to the ultraviolet-ozone treatment into contact with activated carbon 4 contained in an activated carbon treatment device 3 disposed in the circulation path of the electrolytic copper plating solution 1 to remove organic impurities (i.e., organic impurities which have not been decomposed in the ultraviolet-ozone treatment).

As illustrated in FIG. 1, an anode 7 made of an insoluble anode (iridium oxide) and a substrate (cathode) 8 which is a member to be plated are placed in the plating tank 2 in the state of being immersed in the electrolytic copper plating solution 1.

### (Ultraviolet-Ozone Treatment)

The electrolytic copper plating solution 1 used in electrolytic plating is transferred, with a pump (not shown), from the plating tank 2 in which the plating has been performed to a treatment tank in the ultraviolet-ozone treatment device 9 disposed in the circulation path of the electrolytic copper plating solution 1.

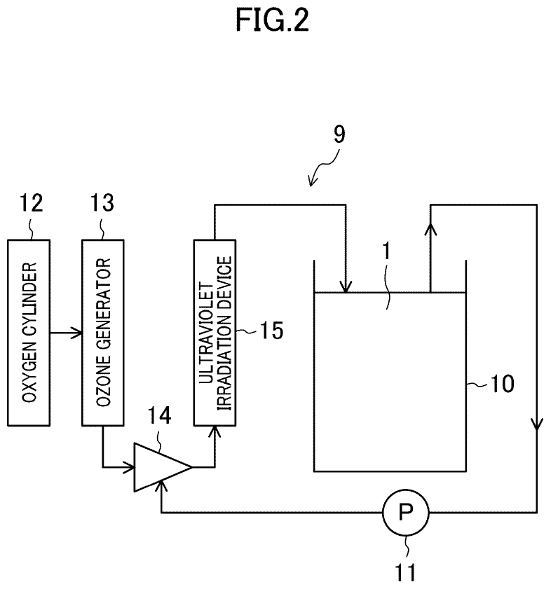

The ultraviolet-ozone treatment device 9 used includes, for example, as illustrated in FIG. 2, a treatment tank 10 for storing the electrolytic copper plating solution 1, a pump 11 for circulating the electrolytic copper plating solution 1 stored in the treatment tank 10, an oxygen cylinder 12 storing oxygen to be converted into ozone, an ozone generator 13 connected to the oxygen cylinder 12 and configured to convert oxygen supplied from the oxygen cylinder 12 to ozone, an ejector 14 connected to the ozone generator 13 and configured to disperse the ozone generated in the ozone generator 13 into the circulating electrolytic copper plating solution 1, and an ultraviolet irradiation device 15 connected to the ejector 14 and the treatment tank 10 and configured to irradiate the circulating electrolytic copper plating solution 1 with ultraviolet ray.

In the ultraviolet-ozone treatment device 9, oxygen supplied from the oxygen cylinder 12 is converted into ozone in the ozone generator 13, and the ozone generated in the ozone generator 13 is dispersed into the circulating electrolytic copper plating solution 1 by the ejector 14. Thus, the additive (a leveler, a brightener, and a carrier) and the organic impurities in the electrolytic copper plating solution are decomposed into carbon dioxide and water.

More specifically, for example, when polyalkylene glycol (polyethylene glycol monoethyl ether) is used as a carrier, first, as shown in the formula (4), ether bonds (—O—) of polyethylene glycol monoethyl ether represented by the formula (A) are cut by the ozone to generate carboxylic acid (acetic acid) represented by the formula (B).

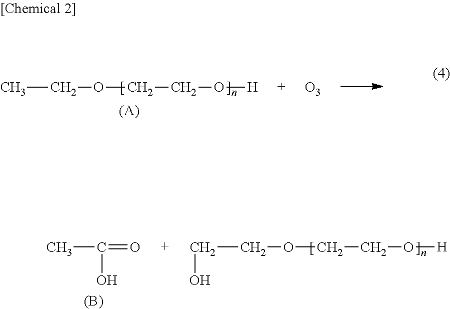

Then, as shown in the formula (5), dissolved oxygen and acetic acid generated in the electrolytic copper plating solution react with each other to generate dicarboxylic acid (oxalic acid) represented by the formula (C).

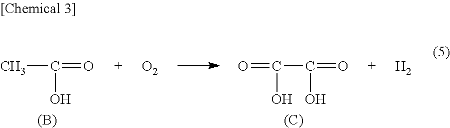

Subsequently, as shown in the formula (6), a carbon-carbon bond in oxalic acid represented by the formula (C) is cut by the ozone in the electrolytic copper plating solution to generate carboxylic acid (formic acid) represented by the formula (D) and carbon dioxide.

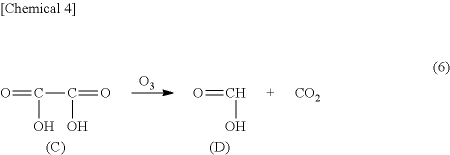

Then, as shown in the formula (7), formic acid represented by the formula (D) is decomposed into carbon dioxide and water by the dissolved oxygen in the electrolytic copper plating solution.

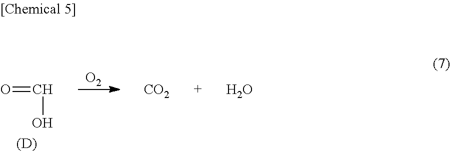

The ultraviolet irradiation device 15 irradiates the circulating electrolytic copper plating solution 1 with ultraviolet ray. Thus, the efficiency of the oxidation by the ozone treatment is improved.

The treatment temperature of the ultraviolet-ozone treatment is not particularly limited and is preferably ordinary temperature to 50° C. This is because if the treatment temperature is less than the ordinary temperature, the reaction rate may decrease, resulting in low oxidation efficiency, and if the treatment temperature exceeds 50° C., the dissolved ozone in the electrolytic copper plating solution 1 may decrease, resulting in low oxidation efficiency.

### (Activated Carbon Treatment)

The electrolytic copper plating solution treated by the ultraviolet-ozone treatment device 9 is transferred from the ultraviolet-ozone treatment device 9 to the activated carbon treatment device 3 disposed in the circulation path of the electrolytic copper plating solution 1 with the pump (not shown).

The electrolytic copper plating solution 1 which has been subjected to the ultraviolet-ozone treatment is circulated and brought into contact with activated carbon 4 stored in the activated carbon treatment device 3 so that organic impurities (organic impurities which have not been decomposed in the ultraviolet-ozone treatment) 5 remaining in the electrolytic copper plating solution 1 are adsorbed to the activated carbon 4 and removed.

As illustrated in FIG. 1, the electrolytic copper plating solution 1 from which the organic impurities have been removed is transferred, with the pump (not shown), from the activated carbon treatment device 3 to the storage vessel 6 disposed in the circulation path of the electrolytic copper plating solution 1, and is returned from the storage vessel 6 to the plating tank 2 with the pump (not shown) in accordance with the amount of the electrolytic copper plating solution 1 transferred from the plating tank 2 to the treatment tank 10 in the ultraviolet-ozone treatment device 9 (e.g., when the capacity of the plating tank 2 is 20000 L, 400 L which is 2% of the capacity).

Further, in the electrolytic copper plating solution 1 which has been subjected to the regeneration treatment and is returned from the storage vessel 6 to the plating tank 2, the additive (i.e., a leveler, a brightener, and a carrier) has been decomposed by the ultraviolet-ozone treatment, and the concentration of the additive is low. Thus, the concentration of the additive can be adjusted in the plating tank 2.

As described above, in the present disclosure, the ultraviolet-ozone treatment and the activated carbon treatment are performed. Thus, it is possible to regenerate the electrolytic copper plating solution without newly preparing another plating solution, by reducing the concentrations of the organic impurities in the plating solution to a level below the standard value at which the plating solution can be continuously used. This makes it possible to continuously use the electrolytic copper plating solution semi-permanently without newly preparing another plating solution.

Further, in the present disclosure, the organic impurities remaining in the electrolytic copper plating solution are decomposed by the ultraviolet-ozone treatment. Thus, compared to the conventional art, the amount of activated carbon used in the activated carbon treatment can be significantly reduced, thereby significantly reducing the recycling costs.

For example, as will be described in Examples later, the ultraviolet-ozone treatment and the activated carbon treatment are performed for each 30 AH/L increase in the amount of current flow in the electrolytic copper plating solution, so that the activated carbon does not need to be performed for each 300 AH/L increase in the amount of current flow. Thus, the amount of activated carbon used in the activated carbon treatment can be significantly reduced.

The embodiments may be modified as follows.

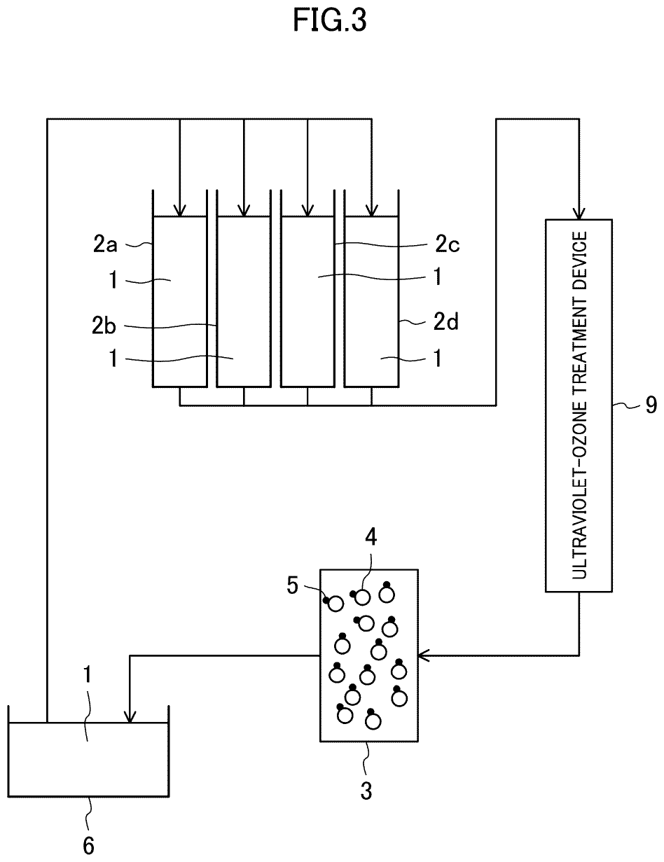

As illustrated in FIG. 3, the plating tank containing the electrolytic copper plating solution 1 may be configured as a hoist type plating tank including a plurality of (four in FIG. 3) plating tanks 2a to 2d. In such a case, as in the embodiments described above, first, the electrolytic copper plating solution 1 stored in the plating tank 2a is oxidized with the ultraviolet-ozone treatment device 9 to decompose organic impurities in the electrolytic copper plating solution 1, and the electrolytic copper plating solution 1 which has been subjected to the ultraviolet-ozone treatment is brought into contact with activated carbon 4 stored in the activated carbon treatment device 3 to remove the organic impurities 5 remaining in the electrolytic copper plating solution 1. The electrolytic copper plating solution 1 from which the organic impurities have been removed is then transferred from the activated carbon treatment device 3 to the storage vessel 6, and is then returned from the storage vessel 6 to the plating tank 2b in accordance with the amount of the electrolytic copper plating solution 1 transferred from the plating tank 2b to the treatment tank 10 in the ultraviolet-ozone treatment device 9 (e.g., when the capacity of the plating tanks 2a to 2d is 400 L, 40 L which is 10% of the capacity). Then, the regeneration treatment is repeatedly performed in the order of the plating tank 2c, the plating tank 2d, the plating tank 2a, and the plating tank 2b. Thus, the same effects as in the embodiments can be obtained.

### EXAMPLES

The following describes the present disclosure more specifically based on Examples and Comparative Examples. However, the present disclosure is not limited to the following Examples.

### Example 1

### <Preparation of Electrolytic Copper Plating Solution>

Mixing and stirring were performed so that the resultant mixture contains 200 g/L copper sulfate pentahydrate, 100 g/L sulfuric acid, 50 mg/L chloride ion, 10 mg/L bis-(3-sodium sulfopropyl) disulfide as a brightener, 1000 mg/L polyethylene glycol monoethyl ether (average molecular weight: 6000) as a carrier, and 100 mg/L diallyldimethylammonium chloride polymer as a leveler. Thus, an electrolytic copper plating solution of Example 1 was prepared.

### <Regeneration Treatment of Electrolytic Copper Plating Solution>

Next, in a plating tank provided with an anode made of insoluble anode (iridium oxide) (60 dm²) and a cathode made of a copper-clad laminate (60 dm²), the prepared electrolytic copper plating solution (200 L) was stored, and the electrolytic copper plating solution was subjected to electrolytic treatment under the conditions of the liquid temperature of 25° C. and the current density of 3 A/dm² until the amount of current flow (degradation degree) thereof reached 1200 AH/L.

Further, 40 L of the electrolytic copper plating solution, which corresponds to 20% of 200 L, was transferred from the plating tank to an ultraviolet-ozone treatment device for each 30 AH/L increase in the amount of current flow, and the electrolytic copper plating solution (40 L) which had been subjected to the electrolytic treatment) was subjected ultraviolet-ozone treatment for 24 hours by using an ultraviolet-ozone treatment device (manufactured by Kairin, trade name: UV-O3-1).

More specifically, in the ultraviolet-ozone treatment device, while the electrolytic copper plating solution (at ordinary temperature) was circulated at 30 L/min using a pump, ozone-containing gas was blown into the electrolytic copper plating solution at 1 L/min at a supply rate of 10 g/hr using an ejector, thereby performing the ozone treatment. Further, the circulating electrolytic copper plating solution was irradiated with ultraviolet ray at a wavelength of 254 nm using an ultraviolet irradiation device, thereby performing ultraviolet ray treatment.

Then, the electrolytic copper plating solution which had been treated by the ultraviolet-ozone treatment device is transferred from the ultraviolet-ozone treatment device to a storage vessel via an activated carbon treatment device at a rate of 40 L/60 min.

More specifically, first, the electrolytic copper plating solution was brought into contact with activated carbon by using an activated carbon filter (outside diameter: 65 mm, inner diameter: 30 mm, length: 250 mm, average particle diameter: 20 μm) as an activated carbon treatment device, thereby performing activated carbon treatment.

Then, the electrolytic copper plating solution (40 L) which has been subjected to the activated carbon treatment was transferred from the activated carbon treatment device to the storage vessel disposed in the circulation path of the electrolytic copper plating solution and was then transferred from the storage vessel to a plating tank.

### <Measurement of TOC Value>

The total organic carbon (TOC) values [ppm] in the electrolytic copper plating solution which had been subjected to the regeneration treatment at the respective amount of current flow of 0 AH/L (new bath), 100 AH/L, 200 AH/L, 300 AH/L, 400 AH/L, 500 AH/L, 600 AH/L, 700 AH/L, 800 AH/L, 900 AH/L, 1000 AH/L, 1100 AH/L, and 1200 AH/L were measured, and were determined as the amounts of organic impurities remaining in the electrolytic copper plating solution.

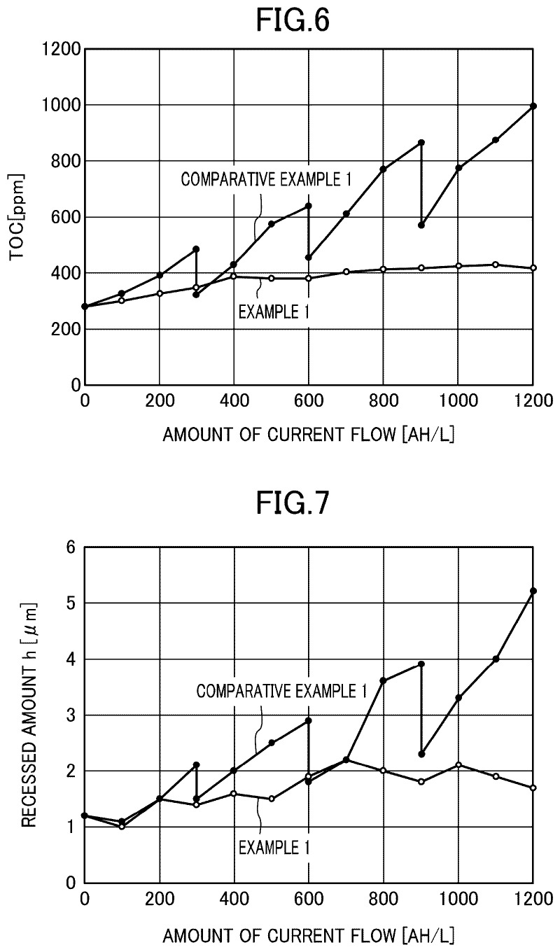

More specifically, the TOCs were measured using a total organic carbon analyzer (manufactured by Shimadzu Corporation, trade name: TOC-L CSH/CSN). The results are shown in FIG. 6.

If the TOC values in the plating bath are 1000 ppm or less, the plating bath can be used semi-permanently and continuously without newly preparing another plating solution.

### <Measurement of Concentration of Additive>

Next, the concentrations of the additives (a brightener, a carrier, and a leveler) in the electrolytic copper plating solution (amount of current flow: 0 AH-L) before the regeneration treatment and the electrolytic copper plating solution (the amount of current flow: 1200 AH-L) after the regeneration treatment were measured. More specifically, by using a CVS analyzer (manufactured by ECI Technology, trade name: QL-5EZ), the concentration [mg/L] of bis-(3-sodium sulfopropyl) disulfide as a brightener, the concentration [mg/L] of polyethylene glycol monoethyl ether as a carrier, and the concentration [mg/L] of diallyldimethylammonium chloride polymer as a leveler were measured. Table 1 shows the results of the foregoing.

### <Electrolytic Copper Plating Treatment>

In the electrolytic copper plating solution which had been subjected to the regeneration treatment, the concentrations of the copper, sulfuric acid, chloride ion, brightener, carrier, and leveler consumed in the electrolytic treatment, the ultraviolet-ozone treatment and the activated carbon treatment were analyzed, and refilling and adjustment were performed so that the concentrations of the substances described above reach those described in the preparation of the electrolytic copper plating solution. Thus, an electrolytic copper plating solution used in the electrolytic copper plating treatment of Example 1 was prepared.

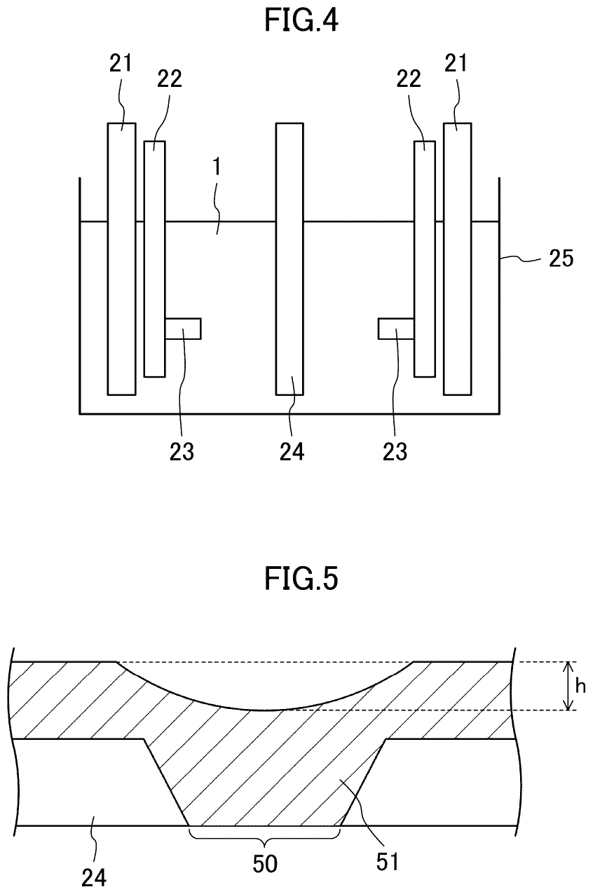

Next, in a cell 25 provided with an anode 21 made of insoluble anode (iridium oxide) (1 dm²) and an eductor nozzle 23 connected to a circulation pipe 22, shown in FIG. 4, the adjusted electrolytic copper plating bath (i.e., 0 AH/L of new bath) and 5 L each of electrolytic copper plating solutions which had been subjected to the regeneration treatment at the respective amount of current flow of 100 AH/L, 200 AH/L, 300 AH/L, 400 AH/L, 500 AH/L, 600 AH/L, 700 AH/L, 800 AH/L, 900 AH/L, 1000 AH/L, 1100 AH/L, and 1200 AH/L were collected and stored, and a substrate (cathode) 24, which was a member to be plated having a via hole with an opening diameter of 80 μm and a depth of 60 μm was subjected to the electrolytic copper plating treatment using the electrolytic copper plating solution (5 L) at each amount of current flow for 45.4 min under the conditions of a liquid temperature of 25° C., a current density of 2 A/dm², and a jet flow rate of 1 L/min.

Next, a recessed amount h [μm] of a via hole filling plating 51 formed in the via hole 50 of the substrate 24 shown in FIG. 5 was measured using a laser microscope (manufactured by KEYENCE CORPORATION, trade name: VK-X3000). The results are shown in FIG. 7.

### Comparative Example 1

An electrolytic copper plating solution was prepared in the same manner as in Example 1. Then, the following electrolytic treatment was performed, and the following activated carbon treatment was performed as a regeneration treatment of the electrolytic copper plating solution. Subsequently, the electrolytic copper plating solution which had been subjected to the activated carbon treatment was circulated to be transferred from the activated carbon treatment device to the plating tank.

### <Electrolytic Treatment>

First, in a plating tank provided with an anode made of insoluble anode (iridium oxide) (60 dm²) and a cathode made of a copper-clad laminate (60 dm²), the prepared electrolytic copper plating solution (200 L) was stored, and the electrolytic copper plating solution was subjected to electrolytic treatment under conditions of a liquid temperature of 25° C. and a current density of 3 A/dm² until the amount of current flow (degradation degree) thereof reached 1200 AH/L.

### <Activated Carbon Treatment>

For each 300 AH/L increase in the amount of current flow in the electrolytic copper plating solution reached 300 AH/L, all electrolytic copper plating solution (200 L) stored in the plating tank was circulated at 50 L/min and subjected to the activated carbon treatment using an activated carbon treatment device for 24 hours.

More specifically, first, the electrolytic copper plating solution was brought into contact with activated carbon by using an activated carbon filter (outside diameter: 65 mm, inner diameter: 30 mm, length: 250 mm, average particle diameter: 20 μm) as an activated carbon treatment device, thereby performing the activated carbon treatment. Then, the electrolytic copper plating solution which had been subjected to the activated carbon treatment was transferred from the activated carbon treatment device to the plating tank.

Then, the TOC values [ppm] and the concentrations [mg/L] of the additives were measured in the same manner as in Example 1. The results are shown in FIG. 6 and Table 1.

In the electrolytic copper plating solution which had been subjected to the regeneration treatment, the concentrations of the copper, sulfuric acid, chloride ion, brightener, carrier, and leveler consumed in the electrolytic treatment and the activated carbon treatment were analyzed, and refilling and adjustment were performed so that the concentrations of the substances described above reach those described in the preparation of the electrolytic copper plating solution in Example 1. Thus, an electrolytic copper plating solution used in the electrolytic copper plating treatment of Comparative Example 1 was prepared. In the same manner as in Example 1, the electrolytic copper plating treatment was performed using the electrolytic copper plating solution (5 L) at each amount of current flow of 0 AH/L to 1200 AH/L, and a recessed amount h [μm] of a via hale filling plating 51 was measured. The results are shown in FIG. 7.

TABLE 1

| | | Concentration [mg/L] | |
|---|---|---|---|
| | | Before regeneration | After regeneration |
| | Component | treatment | treatment |
| Example 1 | Brightener | 10 | 0 |
| | Carrier | 1000 | 0 |
| | Leveler | 100 | 0 |
| Comparative | Brightener | 10 | 6 |
| Example 1 | Carrier | 1000 | 10 |
| | Leveler | 100 | 60 |

As can be seen from FIG. 6, in Example 1, the organic impurities were decomposed and removed by the ultraviolet-ozone treatment and the activated carbon treatment, and the TOC values in the plating solution remained around 400 ppm, which were largely below the standard value (1000 ppm) for continuous use of the plating solution, at the amount of current flow up to 1200 AH/L.

As can be seen from FIG. 7, in Example 1, the recessed amount h [μm] of the via hole filling plating 51 was smaller than that in Comparative Example 1, and at each amount of current flow up to 1200 AH/L, the recessed amount h [μm] of the via hole filling plating 51 remained about 1 to about 2 μm. It was thus demonstrated that even after continuous use, the plating performance did not deteriorate, indicating that the plating solution could be used semi-permanently without newly preparing another plating solution.

In contrast, in Comparative Example 1, the activated carbon treatment was only performed without performing the ultraviolet-ozone treatment. Thus, as can be seen from FIG. 6, the removal of the organic impurities was insufficient, the TOC values in the plating solutions increased with the increase in the amount of current flow, and even when the activated carbon treatment was performed for each 300 AH/L increase in the amount of current flow, and the TOC values at the amount of current flow of 1200 AH/L was 1000 ppm, which was the standard value, or more.

Further, in Comparative Example 1, as can be seen from FIG. 7, the recessed amount h [μm] of the via hole filling plating 51 was large, and the plating performance decreased due to accumulation of the organic impurities caused by the long-term use, indicating that another plating solution needs to be newly prepared.

As shown in Table 1, in Example 1, unlike Comparative Example 1, the concentrations of the additives (a brightener, a carrier, and a leveler) in the electrolytic copper plating solution (amount of current flow: 1200 AH/L) after the regeneration treatment were 1 mg/L or less, indicating that the additives (the leveler, the brightener, and the carrier) in the electrolytic copper plating solution were reliably decomposed by the ultraviolet-ozone treatment.

The method for regenerating an electrolytic copper plating solution according to the present disclosure is suitably used in electrolytic copper plating solution for use in formation of plated bumps of semiconductor chips and package substates in particular.

What is claimed is:

1. A method for regenerating an electrolytic copper plating solution containing a copper ion and at least one additive selected from the group consisting of a brightener, a carrier, and a leveler, the method comprising:
ultraviolet-ozone treatment of oxidizing the electrolytic copper plating solution to decompose an organic impurity in the electrolytic copper plating solution; and
activated carbon treatment of bringing activated carbon into contact with the electrolytic copper plating solution which has been subjected to the ultraviolet-ozone treatment to remove the organic impurity in the electrolytic copper plating solution.

2. The method of claim 1, wherein the electrolytic copper plating solution is circulated from a plating tank containing the electrolytic copper plating solution, and the electrolytic copper plating solution from which the organic impurity has been decomposed and removed is returned to the plating tank.

3. The method of claim 1, wherein the electrolytic copper plating solution is a copper sulfate plating solution.

4. A system for regenerating an electrolytic copper plating solution containing a copper ion and at least one additive selected from the group consisting of a brightener, a carrier, and a leveler, the system at least comprising:
an ultraviolet-ozone treatment device configured to oxidize the electrolytic copper plating solution to decompose an organic impurity in the electrolytic copper plating solution; and
an activated carbon treatment device configured to bring activated carbon into contact with the electrolytic copper plating solution which has been subjected to an ultraviolet-ozone treatment to remove the organic impurity in the electrolytic copper plating solution.
